(19) United States
(12) Patent Application Publication
(10) Pub. No.: US 2015/0088767 A1
(43) Pub. Date: Mar. 26, 2015

(54) REUSABLE SHIPPING PACKAGES FOR ELECTRONIC MARKETPLACE SELLERS

(71) Applicant: Amazon Technologies, Inc., Reno, NV (US)

(72) Inventor: Anand Varadarajan, Bellevue, WA (US)

(73) Assignee: Amazon Technologies, Inc., Reno, NV (US)

(21) Appl. No.: 14/038,354

(22) Filed: Sep. 26, 2013

(51) Int. Cl. G06Q 10/00

(52) U.S. Cl. CPC G06Q 10/30
USPC 705/308

(57) ABSTRACT

Techniques for improving the efficiency of an electronic marketplace are disclosed herein. In particular, methods for implementing reusable packaging in fulfillment of orders by participants who are both consumers and sellers in an electronic marketplace are described. The reusable packaging may be provided on a one-to-one basis as compared to a seller's pending outgoing orders and an order placed by the seller acting as a consumer to an electronic marketplace, on a one-to-N basis as compared to the seller's selling history, or may be based on a multi-modal assessment of the seller's past and pending orders and accommodate multiple representative orders. Reusable packaging may include a wide variety of containers and additional materials to aid a seller in its use.

### BACKGROUND

Third-party sellers in an electronic marketplace may occasionally use inefficient or improper packaging and may be wasteful of packaging materials when shipping items. In addition, third-party sellers may not properly fulfill orders because they use incorrect shipping information or incorrect postage. Third-party sellers' mistakes and inefficiencies can cost an electronic marketplace time, money, and consumer goodwill by forcing the electronic marketplace to correct mistakes, which delay the completion of an order. Furthermore, the expansion of electronic shopping has created a surplus of used shipping containers. These containers consume energy and natural resources in production and, all too often, face disposal after one use.

### BRIEF DESCRIPTION OF THE DRAWINGS

Various embodiments in accordance with the present disclosure will be described with reference to the drawings, in which:

FIG. 1 illustrates an example of a system wherein packaging information of a pending order from a seller is related to a shipping container choice as described herein in accordance with at least one embodiment;

FIG. 2 illustrates an example of a system wherein packaging information of a pending sale from a consumer is related to a shipping container choice as described herein in accordance with at least one embodiment;

FIG. 3 illustrates an example of a system wherein packaging information of cumulative sale history is related to a shipping container choice as described herein in accordance with at least one embodiment;

FIG. 4 is a schematic diagram depicting aspects of an example reusable packaging determination facility in accordance with at least one embodiment;

FIG. 5 is a flow diagram depicting an example method of implementing a packaging choice based on a pending consumer order in accordance with at least one embodiment;

FIG. 6 is a flow diagram depicting an example method of implementing a packaging choice based on historical seller order data in accordance with at least one embodiment;

FIG. 7 is a flow diagram depicting an example method of implementing a packaging choice based on a plurality of packaging modes in accordance with at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Embodiments of the present disclosure are directed to, among other things, methods for improving the efficiency of shipping and receiving packages by and for third-party consumers and sellers who participate in an electronic marketplace. Parties relevant to an embodiment as described below include sellers, third-party sellers, an electronic marketplace and consumers.

A seller is a participant in an electronic marketplace who fills roles as both a consumer who orders items from the electronic marketplace or from other electronic marketplace participants and as a seller who receives and fulfills orders placed directly or indirectly by other consumers within the electronic marketplace. The term “third-party seller” describes a marketplace participant who receives and fulfills orders but may or may not participate in the marketplace as a consumer.

Packaging may include but is not limited to shipping containers, dunnage, shipping labels, packaging instructions, postage labels or any other materials that may aid any market participant in fulfilling an order. Containers may be of any material or form, including cards, envelopes, cardboard boxes, boxes of any other material, crates, pallets and any other form of container in or on which an item may be shipped. Containers may also be of any size. Packaging may be reusable.

Reusable packaging includes any container that is purposed to ship an item, and either intended for re-use, or actually repurposed such that any part or all of the same packaging may be used to ship another item. Reusable does not imply that the packaging necessarily differs in any material respect from a container normally intended for a single use. Reusable packaging may include containers that are designed to be more durable than conventional or single-use shipping containers, such as but not limited to heavy-duty cardboard boxes, plastic totes, crates, reinforced containers and conventional cardboard boxes with supplementary packaging attributes designed to promote re-use. Reusable packaging may also refer to any dunnage, shipping labels, packaging instructions, postal labels or any other materials that may aid a seller in the use of a received container for an outgoing shipment.

Alternative packaging refers to any packaging material that is substituted for or added to default packaging, where the default packaging is that which would ordinarily be used to ship an item without consideration of the potential re-use of the packaging materials.

In some embodiments, a seller may place a request or an order for one or more items from an electronic marketplace, herein referred to as a seller order. Data related to a seller order is herein referred to as seller order data, and may describe any characteristics of the item or items such as size, weight, dimensions or durability; as well as packing instructions, customer requests and indications, destination, origin or other shipping channel characteristics; and may also include detailed order information such as price, quantity, promotions, customer requests, customer comments or other information.

Seller order data may also include metadata or contextual data, which in the context of these embodiments, generally refers to information stored in a data store or other non-transitory computer-readable media that may relate to seller order data and may be accessible to one or more provider computers associated with the electronic marketplace. One example of metadata or contextual data may be comprehensive information regarding packing requirements for an item. One or more service provider computers of an electronic marketplace could retrieve metadata or contextual data based on limited information, such as a short item identifier included in a seller order. One specific example of metadata or contextual data may be, for the item “apples,” packing information including correct dunnage for fruit as well as shipping instructions for managing perishable items.

At any time, a seller may receive a request or a purchase order either from a consumer through the electronic marketplace or from the electronic marketplace on behalf of a consumer, herein called a “consumer order.” Data related to this second request or consumer order is herein referred to as “consumer order data” or “consumer order information” and may include the same parameters as seller order data. In some embodiments, the seller provides the one or more items required to fulfill the consumer order to a fulfillment center (e.g., a warehouse, distribution facility, etc.) that is associated with the electronic marketplace, herein called a “fulfillment order.” In some embodiments, the electronic marketplace can receive or obtain data and information from the seller as they provide the items required for the fulfillment order. In still other embodiments, the fulfillment center associated with the electronic marketplace may gather or obtain the data and information associated with the seller fulfilling the consumer orders.

In some embodiments the consumer order data and the seller order data may each be stored on one or more non-transitory data storage media. The non-transitory data storage media may be stored on one or more servers in communication with the one or more service provider computers over a network. Both consumer order data and seller order data may include information that is either related to the size or nature of the packaging required or preferred to ship the order, or includes information from which the preferred packaging may be inferred or otherwise substantially determined.

In some embodiments, the seller order data or the consumer order data (or both) may be linked to a profile that is associated with a particular individual seller. A seller profile may contain cumulative consumer and seller order data that has been accumulated and stored over time, and may contain metadata produced by processing the cumulative data.

Cumulative consumer and seller order data may be collected and processed to form representative and/or historical order data for a seller. Representative and/or historical order data may include any characteristic above described as pertaining to consumer or seller order data, and generally refers to an approximation or an instance of seller order data that would accommodate some, most or all seller orders of a particular seller. The representative and/or historical order data may vary depending on the complexity of a seller's order history. For example, in some embodiments, ways of establishing representative and/or historical order data may include determining a packaging scheme that accommodates all of the historical seller orders of a seller.

In some embodiments, for sellers with complex shipping histories, establishing representative order data may involve determining a packaging scheme that accommodates all historical seller orders of a seller subject to one or more logical restrictions. The one or more logical restrictions can include only utilizing data that is dated back by a particular period of time, including only packages up to a certain size, or otherwise restricting to an arbitrary degree any attribute or combination of attributes such as size, weight or frequency that an item is ordered. Establishing representative order data may also involve determining a relationship between a particular order and any time-related or frequency-related function such as orders for particular item types placed with high frequency around certain dates, or orders placed with a predictable frequency. Representative order data may be modified subject to intelligent logic or other means to optimize the provision of reusable packaging, such that appropriate reusable packaging is sent to sellers with functionally optimized frequency. Representative order data may also form part of a seller profile.

In some embodiments, packaging required to fulfill a seller order may also be sufficient for a seller to fulfill or provide one or more items associated with his role as a fulfillment seller or electronic marketplace seller. In some embodiments, an electronic marketplace may determine that packaging required to fulfill a consumer order may also be sufficient for a seller order, where the seller may provide or fulfill the consumer order in his capacity as a merchant. In accordance with at least one embodiment, a single seller order may be compared with one or more fulfillment orders. Fulfillment orders can include fulfillment order data and may represent orders that are fulfilled by the seller in their capacity as a merchant associated with the electronic marketplace or as a participant with a fulfillment center associated with an electronic marketplace. In some embodiments, if the comparison results in match, the default packaging ordinarily indicated to fulfill the fulfillment order may be used. The seller may be informed electronically that the seller order packaging is suitable for re-use. Accordingly, the seller may receive the items associated with the seller order from the electronic marketplace in packaging which may be re-used to fulfill a fulfillment order. In some embodiments, a single instance of consumer order data, e.g., a single order, may be compared with one or more of current seller order data, historical seller order data or representative seller order data derived from cumulative seller order data. If the comparison results in a match, the default packaging ordinarily indicated to fulfill the consumer order may be used. The seller may be informed by electronic means that the seller order packaging is suitable for re-use to fulfill the consumer order. The seller may further be optionally provided, either in the seller order or separately, with any or all of some combination of packaging material, dunnage, shipping labels, packaging instructions, postal labels or other materials that may aid the seller in fulfilling the consumer order.

In some further embodiments, the seller may be informed of the match, and optionally be provided with a choice whether or not to receive any or all of some combination of packaging material, dunnage, shipping labels, packaging instructions, postal labels or other materials that may aid the seller in fulfilling pending or future orders.

In some embodiments, packaging indicated to fulfill a pending consumer order may not always be sufficient to also fulfill either a pending or a representative seller order. In such a case, a seller is optionally informed of the absence of a match, and optionally provided a choice of requesting that his order be filled using reusable packaging that differs from the default, or alternative reusable packaging that is suitable for shipping both the consumer order and the pending or representative seller order.

In some embodiments, alternative reusable packaging may be automatically provided in lieu of the default packaging. Alternatively, the seller may be provided with a choice of specifying, for inclusion in either her electronic marketplace profile or seller information data, whether or not substitution of the alternate packaging for the default packaging is preferred, and thereafter to provide the preferred choice automatically. Optionally, alternative reusable packaging may be sent in addition to default packaging used to ship the filled seller order.

The provisioning of alternative reusable packaging may be based additionally on frequency or demand data derived from the cumulative seller order information. If a seller has a predictable pattern of sales of items having particular characteristics, and the pattern indicates likelihood that the seller will require a shipping container within a period of time, alternative packaging may be provided to the seller even in the absence of a pending seller order. The alternative packaging may be provided either as the packaging of a seller order or provided separately.

In some embodiments, a seller may have a predictable pattern of sales of items that best fit bi-modal or multi-modal sets of characteristics. In such cases, multiple representative order data may be generated that better fit the order characteristics than single representative order data. A computer system may predict, based on historical order data, which representative order data is most likely to fit a future seller order profile. An instance of reusable packaging matching may be substituted as alternative packaging in a seller order and/or consumer order to the seller in light of this selected representative order data, and the history of reusable packaging sent to the seller may be included in the seller's profile. This history may be incorporated, for example, into a machine learning algorithm that predicts the optimal representative order selection such that reusable packaging of multiple types may be provided at intervals which track predicted packaging requirements.

A recommendation may be provided to the seller permitting the seller to choose between more than one type of alternative packaging in light of multiple representative order data. Optionally, the alternative reusable packaging may be chosen automatically based on the pattern of shipments sent by the seller, or provided automatically in response to a particular instance of seller order information such as a pending order.

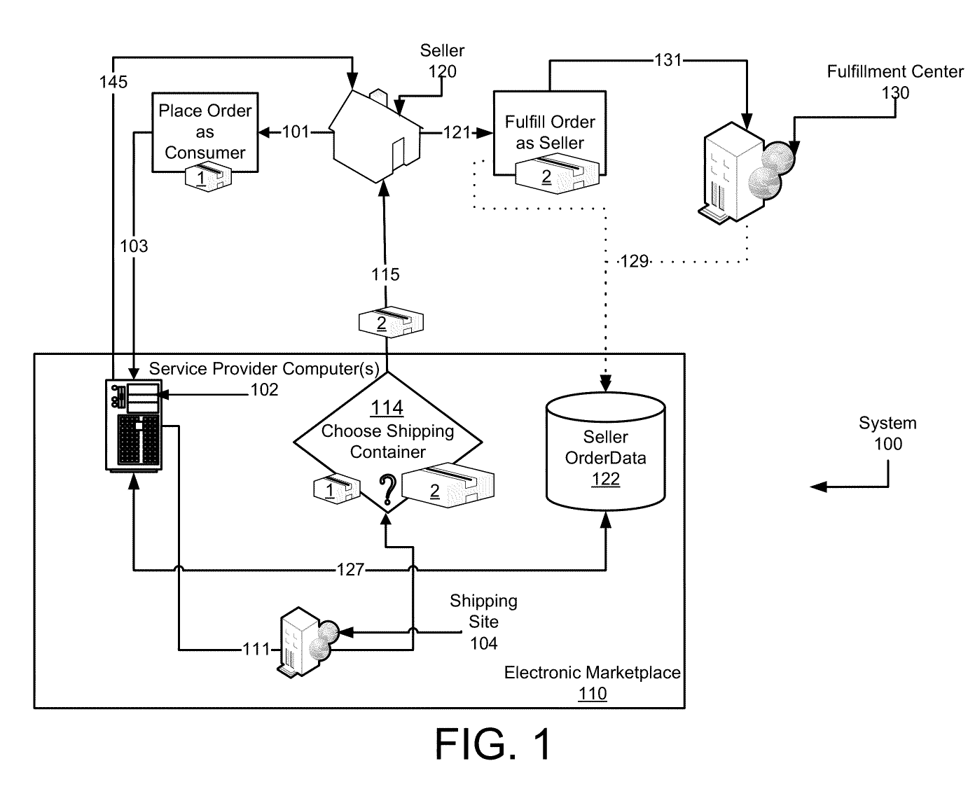

FIG. 1 depicts a system 100 wherein packaging information of a pending order from a seller is related to a shipping container choice in accordance with various embodiments. The system 100 shows the flow of information, items and packaging materials between an electronic marketplace 110, a seller 120, and a fulfillment center 130 in accordance with some embodiments. A seller 120 places 101 seller orders an electronic marketplace 110 and also fulfills 121 fulfillment orders. In some embodiments, the seller 120 is assumed to have placed 101 an order and also to have a pending order to fulfill 121.

Data from the order placed 101 by the seller 120 is transmitted 103 to one or more service provider computers 102 of the electronic marketplace 110. The one or more service provider computers 102 may directly process the seller order data and any associated metadata. Additionally, information regarding a pending fulfillment order may be relayed 129 from the seller 120 or the fulfillment center 130 across one or more networks to the electronic marketplace 110 and ultimately to the one or more service provider computers 102 in communication with a seller order data store 122.

In an embodiment, once data from an order placed by the seller 120 is communicated 103 to the electronic marketplace 110, a determination 114 of which shipping container used to fulfill the seller order can take place within the electronic marketplace 110 (e.g., by the service provider computer(s)). In some embodiments, the one or more service provider computers 102 determine which shipping container, 1 or 2, should be selected to fulfill the seller order and in some embodiments communicate 111 a shipping site 104. The one or more service provider computers 102 can make this determination by communicating with the seller order data store 122. The one or more service provider computers 102 can select a shipping container as well as optional additional packaging based on the combination of data. The selected shipping container and packaging can be applied to the fulfilled seller order and sent 115 to the seller 120 from the shipping site 104. For example, in an embodiment herein visually described, the indicated seller order packaging 1 is represented as a small container compared to the indicated fulfillment order packaging 2, which is larger. Because a small and large item could each fit in the container of packaging 2, in this example, the indicated fulfillment packaging 2 is selected, which is then sent 115 to the seller 120. The seller 120 may choose to reuse the packaging 2 when he or she fulfills 121 an order as a seller for a fulfillment order. Alternatively, the seller 120 may retain the received packaging received to fulfill 121 a future fulfillment order.

The seller 120 fulfills 121 fulfillment orders that are shipped 131 to a fulfillment center 130 which optionally inspects, repackages and ships the order to its ultimate destination. The data associated with fulfilled fulfillment orders is optionally transmitted 129 from the seller 120 or the fulfillment center 130 (or both) to the seller order data store 122. In some embodiments, the one or more service provider computers 102 determine which shipping container to utilize to fulfill a seller order and communicate 111 the determination to a shipping site 104 associated with the electronic marketplace 110. Some examples of a shipping site 104 include a warehouse, a retail store, or a shipping transfer point. In some examples, a shipping site 104 may be able to utilize the determination 111 made by the one or more service provider computers 102 to fulfill the shipping order 115, or provide the correct shipping container 1 or 2. A shipping site worker may receive or obtain the information determined by the one or more service provider computers 102 to choose between which shipping containers to utilize to fulfill an order.

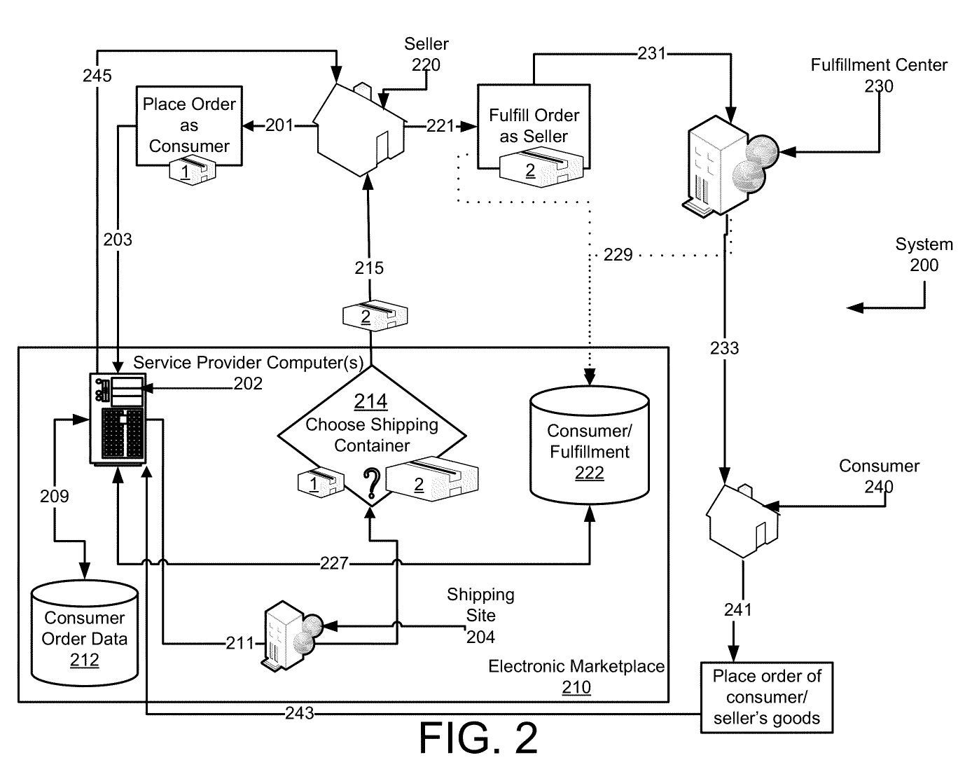

FIG. 2 depicts a system 200 wherein packaging information of a particular sale or pending sale is related to a shipping container choice in accordance with various embodiments. The system 200 shows the flow of information, items and packaging materials between an electronic marketplace 210, a seller 220, a fulfillment center 230 and a consumer 240 in accordance with some embodiments. A seller 120 places 201 seller orders in an electronic marketplace 210 and also fulfills 221 consumer orders placed 241 by consumers 240. Orders placed 241 by a consumer 240 may be transmitted 243 to the electronic marketplace 210 which relays the order 245 to the seller 220. In some embodiments, the seller 220 is assumed to have placed 201 an order and also to have a pending order to fulfill 221 for the consumer 240.

Data from the order placed 201 by the seller 220 is transmitted 203 to one or more service provider computers 202 of the electronic marketplace 210. The one or more service provider computers 202 may directly process the seller order data or may be in communication 227 with a consumer/fulfillment order data store 222 that stores the fulfillment order data and any associated metadata. In some embodiments, the seller order data is processed by the one or more service provide computers 202 and used in the electronic marketplace 210 to fulfill 211 an order subject to choice of packaging. Additionally, information regarding a pending consumer order placed 241 by the consumer 240, may be relayed 229 from the seller 220 or the fulfillment center 230 across one or more networks to the electronic marketplace 210, and ultimately the one or more service provider computers 202 in communication 209 with a consumer order data store 212.

In an embodiment, once data from an order placed by the seller 220 or a consumer 240, is communicated (e.g., 203 or 243) to the electronic marketplace 210, a determination 214 of which shipping container used to fulfill the seller order can take place within the electronic marketplace 210. In some embodiments, the one or more service provider computers 202 determine which shipping container, 1 or 2, should be selected to fulfill the order and in some embodiments communicate 211 this determination so a shipping site 204. The one or more service provider computers 202 can make this determination by communicating with the consumer order data store 212 and/or the consumer/fulfillment order data store 222. The one or more service provider computers 202 can select a shipping container as well as optional additional packaging based on the combination of data. The shipping container and packaging may be applied to the fulfilled seller order and sent 215 to the seller 220. For example, in an embodiment herein visually described, the indicated seller packaging 1 is represented as a small container compared to the indicated consumer packaging 2, which is larger. Because a small and large item could each fit in the container of packaging 2, in this example, the indicated consumer packaging 2 is selected, which is then sent 215 to the seller 220 to fulfill the seller order. The seller may choose to reuse the packaging 2 when he or she fulfills 221 the consumer order. Alternatively, the seller 220 may retain the packaging received to fulfill a future consumer order.

The seller 220 fulfills 221 consumer/fulfillment orders by shipping 231 the items of the order to a fulfillment center 230 that optionally inspects, repackages and ships 233 the order to its destination, the consumer 240. The data associated with fulfilled consumer/fulfillment orders is optionally transmitted 229 from the seller 220 or the fulfillment center 230 (or both) to the consumer/fulfillment order data store 222. In some embodiments, the one or more service provider computers 202 determine which shipping container to utilize to fulfill an order and communicate 211 the determination to a shipping site 204 associated with the electronic marketplace 210. In some examples, a shipping site 204 may be able to utilize the determination 211 made by the one or more service provider computers 202 to fulfill 215 the shipping order, or provide the correct shipping container 1 or 2. A shipping site worker may receive or obtain the information determined by the one or more service provider computers 202 to choose between which shipping containers to utilize to fulfill an order.

The one or more service provider computers 202 may be any type of computing device such as, but not limited to, a mobile phone, a smart phone, a personal digital assistant (PDA), a laptop computer, a desktop computer, a server computer, a mainframe computer, a thin-client device, a tablet PC, etc. Additionally, it should be noted that in some embodiments, the one or more service provider computers 202 may be executed by one or more virtual machines implemented in a hosted computing environment. The hosted computing environment may include one or more rapidly provisioned and released computing resources, which computing resources may include computing, networking, and/or storage devices. A hosted computing environment may also be referred to as a cloud computing environment. In some examples, the one or more service provider computers 202 may be in communication with the one or more data stores 212 and 222 as described above via networks, or via other network connections. The one or more service provider computers 202 may include one or more servers, perhaps arranged in a cluster or as individual servers not associated with one another. The one or more service provider computers 202 may be in communication with one or more third party computers via networks.

In one illustrative configuration, the one or more service provider computers 202 may include at least one memory and one or more processing units or processors(s). The memory may store program instructions that are loadable and executable on the processor(s), as well as data generated during the execution of these programs. Depending on the configuration and type of the one or more service provider computers 202, the memory may be volatile (such as RAM) and/or non-volatile (such as ROM, flash memory, etc.). The one or more service provider computers 202 or servers may also include additional storage, which may include removable storage and/or non-removable storage. The additional storage may include, but is not limited to, magnetic storage, optical disks and/or tape storage. The disk drives and their associated computer-readable media may provide non-volatile storage of computer-readable instructions, data structures, program modules and other data for the computing devices. In some implementations, the memory may include multiple different types of memory, such as SRAM, DRAM, or ROM.

The memory, and the additional storage, both removable and non-removable, are all examples of non-transitory computer-readable storage media. For example, non-transitory computer-readable storage media may include volatile or non-volatile, removable or non-removable media implemented in any method or technology for storage of information such as computer-readable instructions, data structures, program modules, or other data. The memory and the additional storage are all examples of non-transitory computer-readable storage media. Additional types of non-transitory computer-readable storage media that may be present in the one or more service provider computers 202 may include, but are not limited to, PRAM, SRAM, DRAM, RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by the one or more service provider computers 202. Combinations of any of the above should also be included within the scope of computer-readable media.

The one or more service provider computers 202 may also contain communication connection(s) that allow the one or more service provider computers 202 to communicate with a data store, another computing device or server, user terminals and/or other devices on networks. The one or more service provider computers 202 may also include I/O device(s), such as a keyboard, a mouse, a pen, a voice input device, a touch input device, a display, speakers, a printer, etc.

Some or all of the processes implemented by the system 200 (or any other processes described herein, or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program including a plurality of instructions executable by one or more processors. The computer-readable storage medium may be non-transitory.

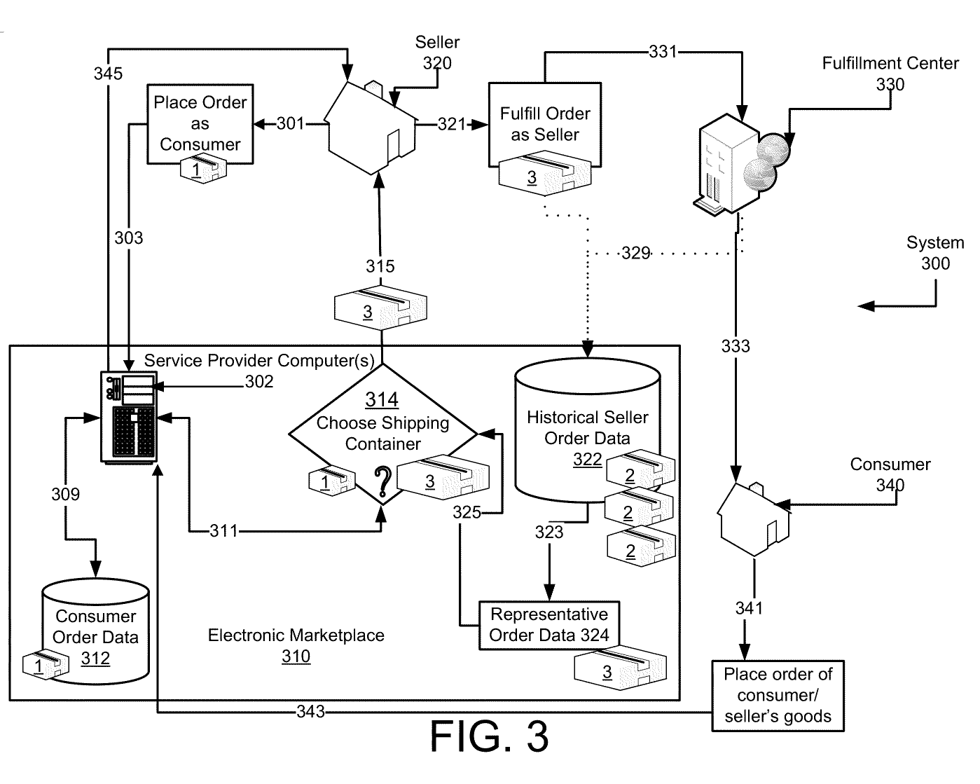

FIG. 3 depicts a system wherein packaging information of historical sales by a seller is related to shipping container choice in accordance with various embodiments. The system 300 describes the flow of information, items and packaging materials between an electronic marketplace 310, a seller 320, a fulfillment center 330 and a consumer 340 in accordance with some embodiments. In an example, at least one process exists for consumers 340 to place 341 orders that are transmitted 343 to the electronic marketplace 310, which relays 345 those orders to the seller 320. Then the seller 320 fulfills 321 consumer orders by shipping 331 the item to a fulfillment center 330, which may check, repackage, and then ship 333 the order to the consumer 340. In the course of this or a comparable process, historical seller order data 322 is maintained and updated. In some embodiments, the historical seller order data may be transmitted 329 from a fulfillment center 330, though in various embodiments this data may also originate directly or indirectly from one or more of the electronic marketplace 310, the seller 320, or the consumer 340. Historical seller order data 322 may include the parameters of the packaging needed to ship consumer orders or fulfillment orders, herein represented as large package 2. This cumulative data is consolidated 323 into representative order data 324, herein represented by large package 3. The representative order data 324 may contain package information such that some, or ideally most, of the consumer/fulfillment orders, 2, would be accommodated by the packaging of 3. The representative order data 324 is transmitted 325 and 311 to one or more service provider computers 301 which will choose the appropriate packaging 314.

The seller 320 may place 301 a seller order, and the order may be transmitted 303 to the electronic marketplace 310 where the seller order data may be stored in a historical seller order data store 322. The seller order data 322 may be used to fulfill the seller order, and may also be processed by the electronic marketplace to determine whether the alternative reusable packaging 3 indicated by the representative order data 324 is suitable to ship 315 the seller order. In the illustrated case, the alternative reusable packaging 3 indicated by the representative order data 324 is sufficient, and is used to ship 315 the fulfilled seller order to the seller 320, such that the reusable package will be available to the seller 320 when he or she next fulfills 321 an order for either fulfillment orders as represented by the historical order data 322 and packaging 2, or any future/pending consumer orders.

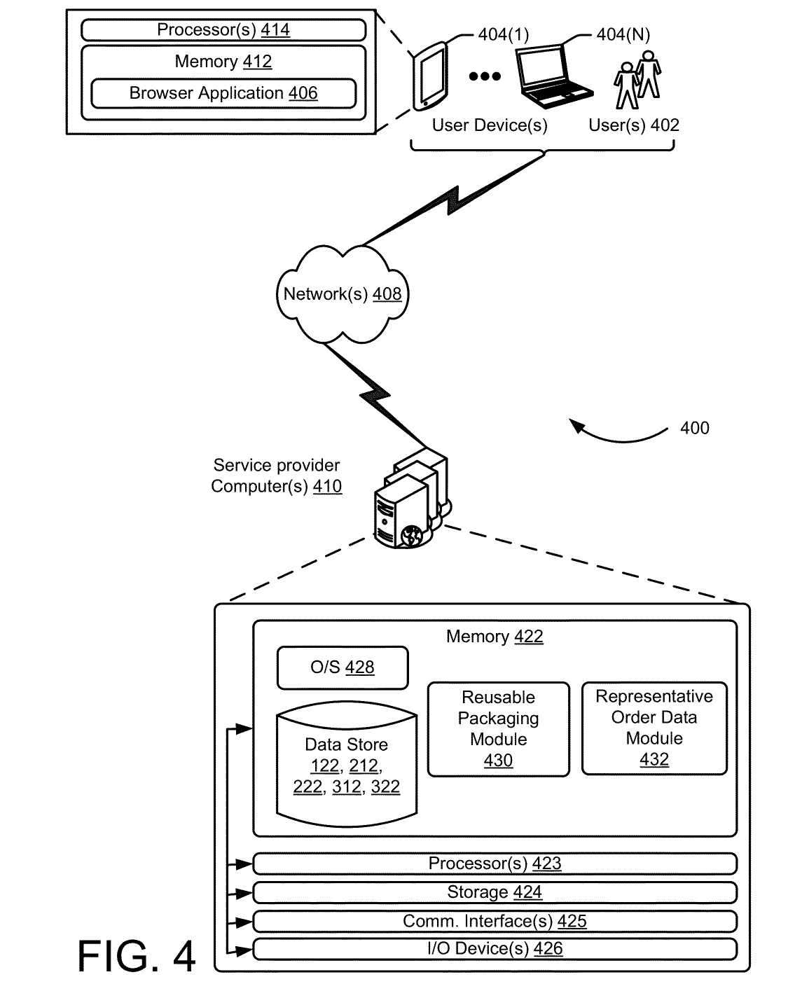

FIG. 4 depicts an illustrative system or architecture 400 in which techniques for selecting and shipping an order in reusable packing may be implemented. In architecture 400, one or more users 402 may utilize user computing devices 404(1)-(N) (collectively, user devices 404) to access a browser application 406 (e.g., a web browser) or a user interface (UI) accessible through the browser application 406, via one or more networks 408. The “one or more users” 402 may be a seller, a consumer, or any party interested in placing orders for consumable items associated with an electronic marketplace. The “browser application” 406 can be any browser control or native application that can access and display a network page or other information. In some aspects, the browser application 406 may display an ordering page associated with an electronic marketplace where a seller can place orders or a consumer can place an order that will be fulfilled by the seller. In some aspects, content presented on the user computing devices 404 by the browser application 406 may be hosted, managed, and/or provided by a computing resources service or service provider, such as by utilizing one or more service provider computers 410. The one or more service provider computers 410 may, in some examples, provide computing resources such as, but not limited to, client entities, low latency data storage, durable data storage, data access, management, virtualization, hosted computing environment solutions, electronic content performance management, etc. The one or more service provider computers 410 may also be operable to provide web hosting, computer application development, and/or implementation platforms, combinations of the foregoing, or the like to the one or more users 402.

In one illustrative configuration, the user devices 404 may include at least one memory 412 and one or more processing units or processor(s) 414. The user devices 404 may also include geo-location devices (e.g., a global positioning system (GPS) device or the like) for providing and/or recording geographic location information associated with the user devices 404.

The memory 412 may store program instructions that are loadable and executable on the processor(s) 414, as well as data generated during the execution of these programs. Depending on the configuration and type of user device 404, the memory 412 may be volatile (such as random access memory (RAM)) and/or non-volatile (such as read-only memory (ROM), flash memory, etc.). The user device 404 may also include additional removable storage and/or non-removable storage including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 412 may include multiple different types of memory, such as static random access memory (SRAM), dynamic random access memory (DRAM), or ROM.

Turning to the contents of the memory 412 in more detail, the memory 412 may include an operating system and one or more application programs or services for implementing the features disclosed herein including placing orders in an electronic marketplace, receiving notifications informing the user that reusable packaging or standard packaging has been selected via the browser application 406 or dedicated applications (e.g., smart phone applications, tablet applications, etc.). The browser application 406 may be configured to receive, store, and/or display network pages generated by a network site associated with an electronic marketplace, or other user interfaces for interacting with the one or more service provider computers 410. Additionally, the memory 412 may store access credentials and/or other user information such as, but not limited to, user IDs, passwords, and/or other user information. In some examples, the user information may include information for authenticating an account such as, but not limited to, a device ID, a cookie, an IP address, a location, or the like. In addition, the user information may include a user 402 provided response to a security question or a geographic location obtained by the user device 404.

In some examples, the network(s) 408 may include any one or a combination of many different types of networks, such as cable networks, the Internet, wireless networks, cellular networks and other private and/or public networks. For example, the network(s) 408 may be a publicly accessible network of linked networks, possibly operated by various distinct parties, such as the Internet. The network(s) 408 may include one or more wireless networks, such as a Global System for Mobile Communications (GSM) network, a Code Division Multiple Access (CDMA) network, a Long Term Evolution (LTE) network, or some other type of wireless network. Protocols and components for communicating via the Internet or any of the other aforementioned types of communication networks are well known to those skilled in the art of computer communications and thus, need not be described in more detail herein. While the illustrated example represents the users 402 accessing the browser application 406 over the network(s) 408, the described techniques may equally apply in instances where the users 402 interact with the one or more service provider computers 410 via the one or more user devices 404 over a landline phone, via a kiosk, or in any other manner. It is also noted that the described techniques may apply in other client/server arrangements (e.g., set-top boxes, etc.), as well as in non-client/server arrangements (e.g., locally stored applications, peer-to-peer configurations, etc.).

As described briefly above, the browser application 406 may allow the users 402 to interact with the one or more service provider computers 410, such as to access content like network pages associated with an electronic marketplace to place orders for consumable items. The one or more service provider computers 410, perhaps arranged in a cluster of servers or as a server farm, may host the browser application 406 and/or hosted computing environment services. Other server architectures may also be used to host the browser application 406 and/or hosted computing environment services. The browser application 406 may be capable of handling requests from many users 402 and serving, in response, various user interfaces that can be rendered at the user devices 404 such as, but not limited to, a network page. The browser application 406 can interact with any type of network site that supports user interaction with an electronic marketplace, or allows a user to place orders for consumable items and fulfill consumable item orders. The described techniques can similarly be implemented outside of the browser application 406, such as with other applications running on the user device 404.

The one or more service provider computers 410 may be any type of computing device such as, but not limited to, a mobile phone, a smart phone, a personal digital assistant (PDA), a laptop computer, a desktop computer, a server computer, a mainframe computer, thin-client device, a tablet PC, etc. Additionally, it should be noted that in some embodiments, the one or more service provider computers 410 may be executed by one or more virtual machines implemented in a hosted computing environment. The hosted computing environment may include one or more rapidly provisioned and released computing resources, which computing resources may include computing, networking, and/or storage devices. A hosted computing environment may also be referred to as a cloud computing environment. In some examples, the one or more service provider computers 410 may be in communication with the user device 404 via the network(s) 408, or via other network connections. The one or more service provider computers 410 may include one or more servers, perhaps arranged in a cluster or as individual servers not associated with one another, or may be implemented as web services consumable via the networks 408.

In one illustrative configuration, the one or more service provider computers 410 may include at least one memory 422 and one or more processing units or processors(s) 423. The memory 422 may store program instructions that are loadable and executable on the processor(s) 423, as well as data generated during the execution of these programs. Depending on the configuration and type of the one or more service provider computers 410, the memory 422 may be volatile (such as RAM) and/or non-volatile (such as ROM, flash memory, etc.). The one or more service provider computers 410 or servers may also include additional storage 424, which may include removable storage and/or non-removable storage. The additional storage 424 may include, but is not limited to, magnetic storage, optical disks and/or tape storage. The disk drives and their associated non-transitory computer-readable media may provide non-volatile storage of computer-readable instructions, data structures, program modules and other data for the computing devices. In some implementations, the memory 422 may include multiple different types of memory, such as SRAM, DRAM, or ROM.

The memory 422, the additional storage 424, both removable and non-removable, are all examples of non-transitory computer-readable storage media. For example, computer readable storage media may include volatile or non-volatile, removable or non-removable media implemented in any method or technology for storage of information such as computer-readable instructions, data structures, program modules, or other data. The memory 422 and the additional storage 424 are all examples of computer storage media. Additional types of non-transitory computer storage media that may be present in the one or more service provider computers 410 may include, but are not limited to, PRAM, SRAM, DRAM, RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by the one or more service provider computers 310. Combinations of any of the above should also be included within the scope of computer-readable media.

The one or more service provider computers 410 may also contain communication interface(s) 425 that allow the one or more service provider computers 410 to communicate with a data store, another computing device or server, user terminals and/or other devices on the network(s) 408. The one or more service provider computers 410 may also include I/O device(s) 426, such as a keyboard, a mouse, a pen, a voice input device, a touch input device, a display, speakers, a printer, etc.

Turning to the contents of the memory 422 in more detail, the memory 422 may include an operating system 428, one or more data stores 122, 212, 222, 312, 322, and/or one or more application programs or services for implementing the features disclosed herein including a reusable packaging module 430 and a representative order data module 432. In an embodiment, the reusable packaging module 430 may obtain or receive data from a seller order data store 122, a consumer order data store 212 or 312, a consumer/fulfillment order data store 222, or a historical seller order data store 322. The reusable packaging module 430 may then perform analysis and determination of whether to select reusable packaging or standard packaging and communicate the decision or determination to the consumer/seller. The representative order data module 432 may, in some embodiments, obtain or receive data from a historical seller order data store 322 and analyze the history of seller orders to determine a reusable packaging that would accommodate some, most or all seller orders of a particular seller based upon the ordering/fulfillment history of that particular seller. For example, if a seller typically or usually provides items in a particular sized package, then that size package can be selected. The representative order data module 432 may than communicate the decision or determination to the seller or any party able to fulfill seller, fulfillment, and consumer orders associated with an electronic marketplace.

In some embodiments, seller orders are communicated by the user 402 via the user device 404 utilizing a browser application 406 via network(s) 408 to one or more service provider computers 410. In still other embodiments, consumer orders that are directed to items sold by the seller via the electronic marketplace may be communicated similarly as seller orders. In other embodiments, the seller is given a choice whether to select the reusable packaging or the default/standard packaging to fulfill the seller order. The above described choice may be communicated via the browser application 406 via networks 408 from the one or more service provider computers 410 utilizing the reusable packaging module 430 and the representative order data module 432.

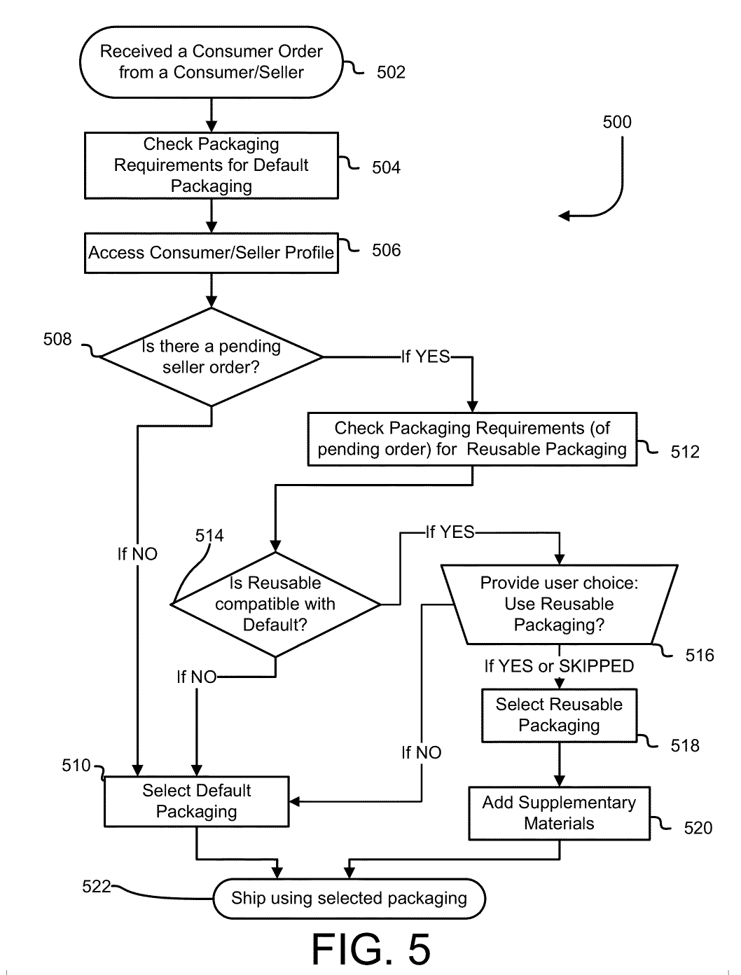

FIGS. 5-7 are flow diagrams showing respective, example processes 500, 600, and 700 for determining and selecting reusable packaging for orders associated with an electronic marketplace, according to at least a few examples. These processes are illustrated as logical flow diagrams, each operation of which represents a sequence of operations that can be implemented in hardware, computer instructions, or a combination thereof. In the context of computer instructions, the operations represent computer-executable instructions stored on one or more non-transitory computer-readable storage media that, when executed by one or more processors, perform the recited operations. Generally, computer-executable instructions include routines, programs, objects, components, data structures and the like that perform particular functions or implement particular data types. The order in which the operations are described is not intended to be construed as a limitation, and any suitable number of the described operations can be combined in any suitable order and/or in parallel to implement the processes.

Additionally, some, any, or all of the processes (or any other suitable processes described herein, or variations and/or combinations thereof) may be performed under the control of one or more computer systems configured with executable instructions and may be implemented as code (e.g., executable instructions, one or more computer programs, applications, or modules) executing collectively on one or more processors, by hardware or combinations thereof. In accordance with at least one embodiment, the code may be stored on a non-computer-readable storage medium, for example, in the form of a computer program including a plurality of instructions executable by one or more processors. The computer-readable storage medium may be non-transitory.

FIG. 5 is a flow diagram depicting an example method of implementing a packaging choice in some embodiments based on a pending seller order. The method 500 depicts a 1:1 comparison of a new consumer order and a pending seller order, which comparison forms the basis for the packaging choice. In an embodiment, the one or more service provider computers 410 receive a seller order from a seller or user 402 at 502, containing data that either includes, or directs the server/one or more service provider computers 410 to search for, packaging requirements of the order. These packaging requirements may also be referred to as default packaging requirements 504. The one or more service provider computers 410 may access a profile of the seller, or other comparable data that contains information pertaining to pending fulfillment orders 506, in order to determine whether or not there is a pending fulfillment order 508. The profile of the seller may be stored in the historical seller order data store 322 and determined by the representative order data module 432 in some embodiments. If there is no pending fulfillment order, the system will select the default packaging 510 and provide instructions to ship the order using the default packaging 522. If there is a pending fulfillment order, the one or more service provider computers 410 will read or reference the packaging requirements of the pending order, which may also be called the reusable packaging 512. The one or more service provider computers 410 may utilize the reusable packaging module 430 in communication with the one or more data stores to determine the packaging requirements of the pending order. The one or more service provider computers 410 may compare the packaging requirements and determine whether the seller order could be fulfilled using the reusable packaging instead of the default 514. If not, the system will select the default packaging 510 and provide instructions to ship the order using the default packaging 522. If the reusable packaging is compatible, the one or more service provider computers 410 will select the reusable packaging 518. In some embodiments, the user may optionally be provided with a choice of using the reusable packaging 516. The optional choice may be provided to the seller or user via the browser application 406. The method may optionally include in the reusable packaging a selection of supplementary materials 520 prior to shipping using the selected reusable packaging 522.

Supplementary materials may include but are not limited to additional dunnage, packaging instructions, shipping instructions, postage, shipping labels, or other materials to facilitate reusable shipping. Compatibility may be related to shipping container size, e.g., a large reusable container may be an adequate substitute for a small default container, optionally with additional dunnage to secure the small item. However, compatibility may also be related to other characteristics such as but not limited to durability, strength, geometrical shape, material, specific labeling, any other relevant physical characteristic or combination of characteristics.

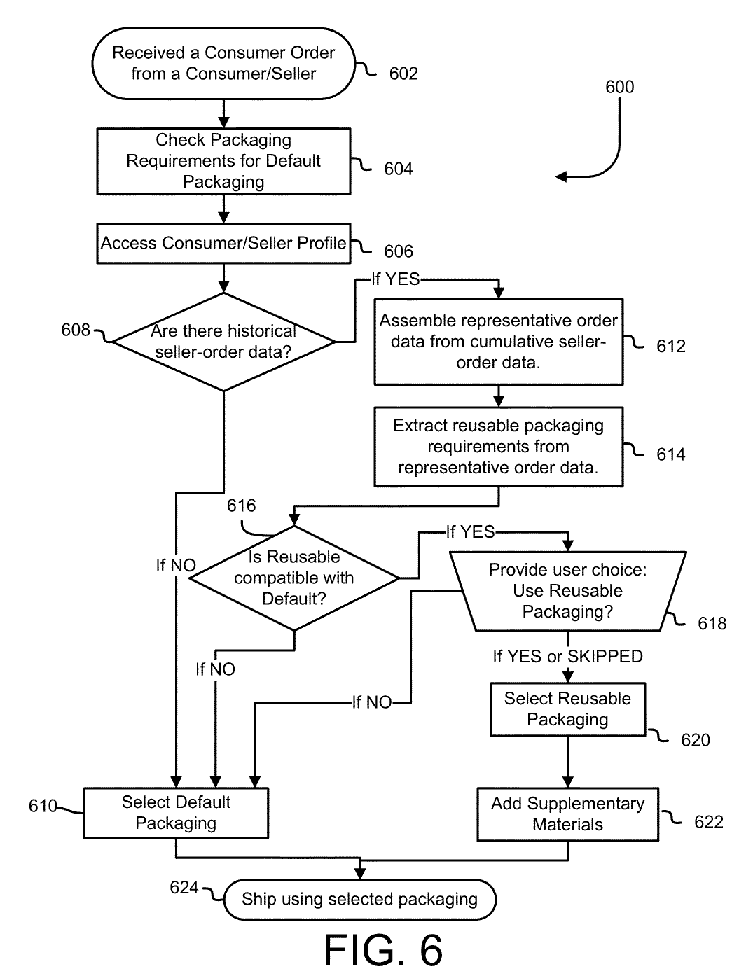

FIG. 6 is a flow diagram depicting an example method of implementing a packaging choice in some embodiments based on seller order data or representative order data. The computer implemented method 600 incorporates a 1:N comparison of a seller order and historical seller order data, which may also include pending orders or consumer orders, and which forms a part of the basis for the packaging choice. In an embodiment, one or more service provider computers 410 receive a seller order from a seller or user 402 at 602, from which packaging requirements are determined 604. The packaging requirements may be determined by the reusable packaging module 430 in communication with the data stores 122, 212, 222, 312, and 322. A profile of the seller can also be accessed 606 and is used to determine whether a seller-order history exists for that seller 608, e.g., whether there is historical data regarding past sales fulfilled by the seller. The profile of the seller may be stored in the historical seller order data store 322 and determined by the representative order data module 432 in some embodiments. If not, the default packaging is selected 610 and the item is shipped 624 using the default packaging 610. If there is historical seller-order data, a representative order is developed from the data 612 and reusable packaging requirements are derived from the representative order 614. In some embodiments, the representative order data module 432 in communication with the historical seller order data store 322 may develop the representative order and derive the reusable packaging requirements. Representative order data may constitute any form of data that suggests or indicates what packaging might be appropriate to fulfill some, most, or all of a seller's past orders or possible future orders. The one or more service provider computers 410 utilizing either the reusable packaging module 430 or the representative order data module 432 may then determine 616 whether the reusable packaging suggested by the representative order data 612, 614 is compatible with the consumer order. If they are not compatible, for example, if the ordered item is significantly larger than the typical seller-order in the history, then the one or more service provider computers 410 select the default packaging 610. If the reusable packaging is compatible, then the reusable packaging is selected 620. Optionally, the system may provide the seller with a notification that reusable packaging is available and offer a choice whether to receive the alternative packaging 618. Additional instructions for providing supplementary materials in addition to a container may be added to the reusable packaging 622, as described above.

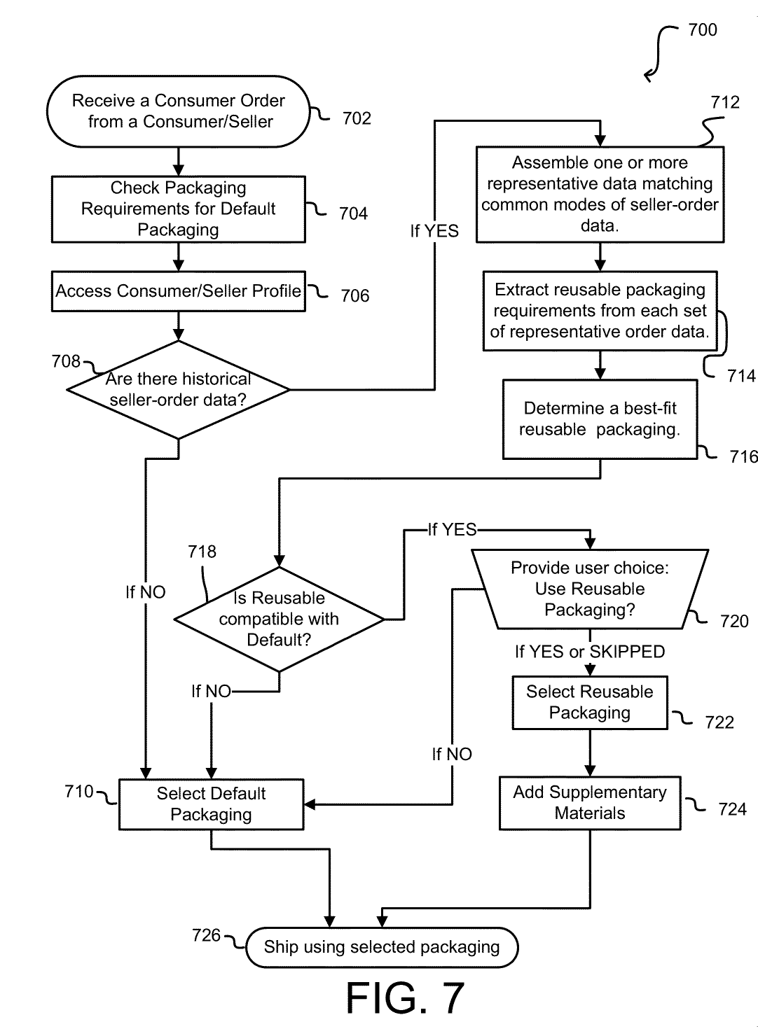

FIG. 7 is an flow diagram depicting an example method of implementing packaging choice in some embodiments based on a plurality of packaging modes indicated by historical seller order data. The computer implemented method 700 incorporates a 1:N comparison of a seller order and a plurality of historical seller order data that may also include pending orders or consumer orders, and in which there may be a plurality of different packaging requirements, or modes of packing requirements. In an embodiment, the one or more service provider computers 410 receives a seller order from a seller or user 402 at 702, from which packaging requirements are determined 704. The packaging requirements may be determined by the reusable packaging module 430 in communication with the data stores 122, 212, 222, 312, and 322. A profile of the seller is also accessed 706 and used to determine whether a seller-order history exists for that seller 708, e.g., whether there is historical data regarding past sales fulfilled by the seller. The profile of the seller may be stored in the historical seller order data store 322 and determined by the representative order data module 432 in some embodiments. If not, the default packaging is selected 710 and the item is shipped 726 using the default packaging 710. If there is historical seller-order data, at least one set of representative order data 712 may be developed from the seller-order data, from which reusable packaging requirements may be derived. In some embodiments, the representative order data module 432 in communication with the historical seller order data store 322 may develop the representative order and derive the reusable packaging requirements. In a data set containing multiple modes, more than one set of reusable packaging requirements may be derived 714. The multiple sets of packaging requirements may be compared against the default packaging, and a best-fit reusable packaging scheme is selected 716. The one or more service provider computers 410 may determine whether the best-fit reusable packaging is compatible with the default packaging for a consumer order 718 utilizing the reusable packaging module 430. If the packaging is not compatible, the default packaging is selected 710. If the packaging is compatible, then the reusable packaging is selected 722. Optionally, the one or more service provider computers 410 may provide the seller with notification that reusable packaging is available, or provide an option not to receive reusable packaging 720. Additional instructions for providing supplementary materials in addition to a container may be added to the reusable packaging 724, as described above.

The various embodiments further can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems and other devices capable of communicating via a network.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm elements described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Embodiments of this disclosure are described herein, including the best mode known to the inventors for carrying out the disclosure. Variations of these embodiments may become apparent to those of ordinary skill in the art upon reading the foregoing description. The inventors expect skilled artisans to employ such variations as appropriate and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications and patents, cited herein are hereby incorporated by reference to the same extent as if each reference were individually and specifically indicated to be incorporated by reference and were set forth in its entirety herein.

What is claimed is:

1. A computer-implemented method comprising:
under control of one or more computer systems configured with executable instructions,
receiving first information about a physical characteristic of a first item to be provided by a seller;
receiving second information about a physical characteristic of a second item ordered by the seller;
receiving historical data associated with other items previously provided by the seller;
selecting a reusable packaging based at least in part on the second information and at least one of the first information or the historical data, the reusable packaging configured to accommodate the first item and the second item;
providing an instruction to package the second item utilizing the selected reusable packaging; and
providing an instruction to ship, to the seller, the second item packaged in the selected reusable packaging.

2. The computer-implemented method of claim 1, further comprising:
indicating to the seller that the reusable packaging may be substituted for a standard packaging.

3. The computer-implemented method of claim 1, further comprising:
sending a message to the seller indicating that the seller has a choice to utilize a standard packaging.

4. A computer-implemented method, comprising:
under control of one or more computer systems configured with executable instructions,
receiving first information about a first item ordered by a seller;
receiving second information about a second item to be provided by the seller;
selecting a reusable packaging based at least in part on the first information and the second information, the reusable packaging configured to accommodate the first item and the second item; and
enabling the first item to be shipped in the reusable packaging.

5. The computer-implemented method of claim 4, wherein the reusable packaging additionally includes at least one of packaging instructions, packing material, dunnage, shipping instructions, shipping tags, or prepared postage specific to aid in shipping the second item.

6. The computer-implemented method of claim 4, further comprising:
sending an instruction to provide to the seller at least one of packaging instructions, packing material, dunnage, shipping instructions, shipping tags, or prepared postage specific to aiding the fulfillment of the second item.

7. The computer-implemented method of claim 4, wherein an order associated with the second item to be provided by the seller was placed prior to the first item ordered by the seller.

8. The computer-implemented method of claim 4, wherein the reusable packaging includes a physical characteristic that improves at least one of durability, ease of packaging, ease of tracking, or ease of measuring compliance with a packaging instruction.

9. The computer implemented method of claim 4 wherein the second information includes cumulative second order data, the cumulative second order data including one or more different packaging requirements that comprise one or more distinct packaging modes.

10. The computer implemented method of claim 9 wherein selecting the reusable packaging includes analyzing the cumulative second order data to determine an optimal packaging mode.

11. The computer-implemented method of claim 4, further comprising:
enabling the first item to be shipped in a standard packaging.

12. A system comprising:
a data store configured to store computer-executable instructions; and
a computing device in communication with the data store, the computing device, when executing the computer-executable instructions, configured to at least:
in response to obtaining fulfillment order data and seller order data:
select a reusable packaging based at least in part on the fulfillment order data and the seller order data, the reusable packaging configured to accommodate an item associated with the fulfillment order data and the seller order data; and
enabling the item associated with the seller order data to be shipped in the reusable packaging.

13. The system of claim 12, further comprising:
providing an instruction to select default packaging for shipping the item associated with the seller order data;
providing an instruction to package the item associated with the seller order data utilizing the default packaging; and
providing an instruction to ship, to the seller, the item associated with the seller order data packaged in the default packaging.

14. The system of claim 12, wherein the reusable packaging includes fulfillment information for the item associated with the fulfillment order data.

15. The system of claim 14, wherein the fulfillment information includes at least one of packaging instructions, packing material, dunnage, shipping instructions, shipping tags, or prepared postage.

16. A computer-readable storage medium having stored thereon computer-executable instructions that, when executed by one or more processors of a computer system, cause the computer system to at least perform operations comprising:
obtaining first order data from a first order placed by a consumer;
obtaining representative order data, the representative order data being an aggregation of a plurality of second orders directed to one or more items fulfilled by a seller;
selecting a reusable packaging based at least in part on the first order data and the representative order data; and
enabling a particular second order of the plurality of second orders to be shipped in the reusable packaging.

17. The computer readable storage medium of claim 16, wherein selecting reusable packaging includes analyzing the representative order data to determine an optimal packaging mode.

18. The computer readable storage medium of claim 16 further comprising:
creating a profile based at least in part on the representative order data for the seller; and
selecting the reusable packaging based at least in part on the profile.

19. The computer readable storage medium of claim 18, wherein the profile dynamically changes based at least in part on updated representative order data for the seller.

20. The computer readable storage medium of claim 16, wherein the representative order data includes a packaging restriction.

21. The computer readable storage medium of claim 20, wherein the packaging restriction includes at least one of a date restriction, a size restriction, a weight restriction, or a frequency of orders placed restriction.

22. The computer readable storage medium of claim 16, wherein the first order data includes at least one of size of an item, weight of an item, dimensions of an item, durability of an item, shipping origin of item, price of item, quantity of item, or customer comments of an item.

23. The computer readable storage medium of claim 16 further comprising:
analyzing a date restriction associated with the first order; and
when the date restriction is met, providing prepared postage with the reusable packaging, to the seller, required to fulfill the first order.
